(19) United States
(12) Patent Application Publication
(10) Pub. No.: US 2012/0023025 A1
(43) Pub. Date: Jan. 26, 2012

(54) SECURE DONATION SYSTEM AND ITS METHOD

(75) Inventors: Phone Lin, Taipei (TW); Chi-Kin Lau, Taipei (TW); Hou-Chun Chen, Taipei (TW); Tsung-Che Yu, Taipei (TW)

(73) Assignee: NATIONAL TAIWAN UNIVERSITY, Taipei (TW)

(21) Appl. No.: 12/873,814

(22) Filed: Sep. 1, 2010

(30) Foreign Application Priority Data
Jul. 22, 2010 (TW) 99124108

(51) Int. Cl. G06Q 99/00; G06Q 40/00; H04L 9/28; G06Q 30/00; H04L 9/30

(52) U.S. Cl. 705/75; 705/26.1; 705/50

(57) ABSTRACT

A secure donation system is connectible to information processing device of donor, donee, and specific store via network. The system includes: a database for storing donation intention data of donor, requirement data of donee, and merchandise and/or service transaction data of specific store; a resource allocation module for generating donee data meeting donation intention data by analyzing and matching donation intention data with requirement data; a donation module for donor to choose donee from donee data meeting donation intention data generated by resource allocation module and for generating donation usage certificate after confirming donation data including donation intention data and donee data; and an authorization module for transmitting donation usage certificate to electronic device of chosen donee, so as for donee to perform verification and shopping in specific store via electronic device. Besides, a secure donation method having mechanisms of requirement matching and postpaid is also provided.

### BACKGROUND OF THE INVENTION

1. Field of the Invention

This invention relates to secure donation systems and related methods, and more particularly, to a secure donation system and a related method having mechanisms of donor requirement matching and postpaid.

2. Description of Related Art

Along with raise of social welfare, donation gradually becomes normal. Except via store donation box or street fundraising, donation may be donated to, for instance, consortium or shetuanfaren of charity, even specific account of government via transfer or remittance method. Donation form is usually traditional cash donating or transfer and remittance in ATM and bank, however, spending many time of donor. Hence, more and more donor donates online via network.

Generally, prior donation method described previously is that the donation from the donor is stored in specific accounts of those fundraising organization, then the fundraising organization distributes the donation to a donee who meets its planning and policy of donation utilization. However, this donation method would lead to many problems, for instance, whether usage process of the donation of the donor is transparent or not, and whether the donee utilizes the donation worthily or not. Furthermore, single account may result in donation chaos, for instance, if one donation of certain donor is donated to the specific donee for specific use, etc., and this is also the doubt of donation that general donor has.

Under consideration of the donor, the donor may want to donate to a specific object, or the donor wants to trance the donation. However, in mode of concentrating donation in the single account, the demands described previously are difficult to be achieved. In condition of ineffective tracing of donation or impossible assigned specific donee, even the donor has high donation intention, he may quit because of unknown donation information. In another aspect, since prior donation accounts and accounting system have no transparent and specific allocation and utilization information, accounting approval and supervising of government are not easily achieved.

Hence, there is a technical issue to be solved immediately that how to provide a secure donation system having mechanisms of requirement matching and postpaid such that the donation could be assigned to a specific donee according to donation intention of a donor, furthermore, utilization process of donation with respect to the donee could be traced, and transparent donation usage condition could be provided for a third party to inquire and check.

### SUMMARY OF THE INVENTION

In view of the above-mentioned problems of the prior art, it is a primary objective of the present invention to provide a secure donation system connectible to information processing devices of a donor, a donee, and a specific store via network. The secure donation system comprises: a database for storing donation intention data of the donor, requirement data of the donee, and merchandise and/or service transaction data of the specific store; a resource allocation module for generating donee data meeting the donation intention data by analyzing and matching the donation intention data with the requirement data; a donation module for the donor to choose the donee from the donee data meeting the donation intention data generated by the resource allocation module, and for generating a donation usage certificate after confirming donation data including the donation intention data and the donee data; and an authorization module for transmitting the donation usage certificate to an electronic device of the chosen donee, so as for the donee to perform verification and shopping in the specific store via the electronic device.

In an embodiment of the present invention, the secure donation system further comprises: a certification module for the donor, the donee, and the specific store to login and perform verification; and a transmission module for the donor, the donee, and the specific store to transmit data via the network.

In another embodiment of the present invention, the specific store has a payment apparatus for verifying shopping with the electronic device, the payment apparatus comprising: a verification unit for the specific store to perform verification with the donation usage certificate in the electronic device via the payment apparatus; and an account unit for the specific store to generate shopping account data of shopping of the donee via the payment apparatus.

Moreover, a secure donation method executed by the secure donation systems described previously is provided in the present invention, comprising the steps of: (a) enabling the donor to submit the donation intention data via the database of the secure donation system; (b) analyzing and matching the donation intention data with the requirement data via the resource allocation module, so as to generate at least one donee data meeting the donation intention data; (c) after the donor chooses the donee from the donee data via the donation module and confirms the donation data, transmitting the donation usage certificate to the electronic device of the chosen donee via the authorization; and (d) enabling the donee to perform verification and shopping in the specific store via the donation usage certificate in the electronic device.

In an embodiment of the present invention, the secure donation method, before step (a), further comprises a step of generating the requirement data of the donee by the secure donation system, so as for the donor in step (c) to choose the donee via the donation module.

In another embodiment of the present invention, step (d) further comprises a step of enabling the specific store to check the donation data corresponding to the donation usage certificate via the payment apparatus, so as to judge if shopping condition of the donee is satisfied or not.

In another embodiment of the present invention, the secure donation method further comprises a step (e) of generating shopping account via the payment apparatus, so as for the specific store to ask payment for the bank, and for the donor to pay for the bank according to the shopping account.

In another embodiment of the present invention, steps (a) to (e) further comprise a step of storing the donation data and the shopping account data in the database, so as for the user to inquire via the secure donation system.

Compared to the prior art, the secure donation system and its method enable the donor to donate in relieved mind via mechanisms of requirement matching and postpaid. The donor may in advance choose the donee meeting his donation intention according to the requirement data of the donee, and then the charity submits the donation usage certificate to the donee; at last, the donee goes shopping in the specific store via the donation usage certificate and the specific store asks payment for the bank according to shopping content. Hence, the donor not only traces use of donation but also dispels doubt of mistrust of donation usage process. Furthermore, the donation does pass through the charity or the donee according the previously described donation and shopping mode, and troublesome transfer process and possible mistrust are avoided. Moreover, whole donation and shopping process are encrypted by asymmetric encryption method, and anonymous report data is provided for inquiry, thereby providing a safe and relieved donation system and method.

### BRIEF DESCRIPTION OF DRAWINGS

The invention can be more fully understood by reading the following detailed description of the preferred embodiments, with reference made to the accompanying drawings, wherein:

FIG. 1 is a system architecture diagram of a secure donation system in accordance with the present invention;

FIG. 2 is a system architecture diagram of the secure donation system in accordance with an embodiment of the present invention;

FIG. 3 is a system architecture diagram of a payment apparatus of a specific store in accordance with the present invention;

FIG. 4 is a flow chart of steps of a secure donation method in accordance with the present invention; and

FIG. 5 is a flow chart of steps of the secure donation method in accordance with an embodiment of the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

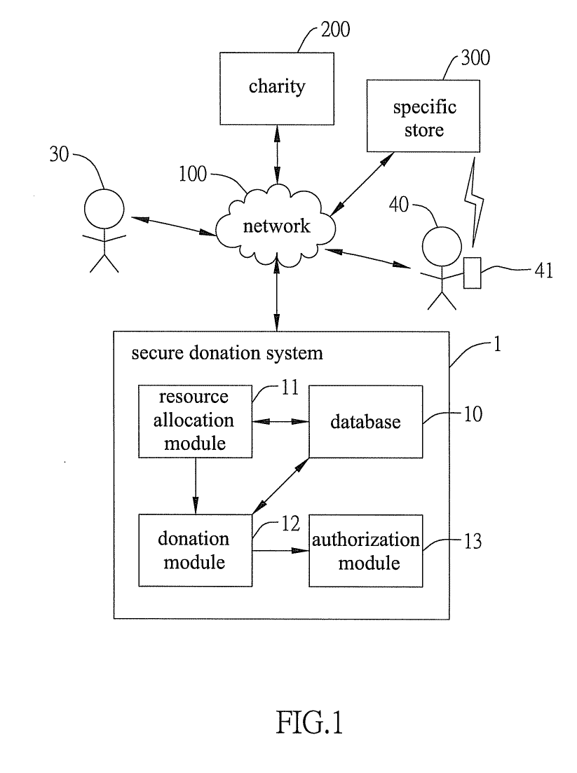

Please refer to FIG. 1 showing a system architecture diagram of a secure donation system 1 in accordance with the present invention. As illustrated in FIG. 1, the secure donation system 1 of the present invention is connected to information processing devices of a donor 30, a donee 40, and a specific store 300 via a network 100. In this illustrative embodiment, the donor 30 in donation behavior, the donee 40, the specific store 300, and a charity 200, etc. transmit data through the information processing devices to the secure donation system 1 and other objects via the network 100. It should be further illustrated that, in the following description of implementation aspect, the donor 30, the donee 40, the specific store 300, and the charity 200 may execute relative operation of donation via distinct information processing device owned by each of them or common information processing device owned by them.

The secure donation system 1 comprises a database 10, a resource allocation module 11, a donation module 12, and an authorization module 13. It should be illustrated that, herein, the donor 30, the donee 40, the specific store 300, and the charity 200 perform data transmission with the secure donation system 1 through the network 100 via the information processing device. That is, each unit described previously which may be in different or same location may complete data transmission of donation, shopping, payment, or report, etc. only by connecting to the secure donation system 1 through the network 100.

Different from a prior network donation manner, since the secure donation system 1 mentioned in the present invention preserves requirements requested by the donee 40, the donee 40 may perform shopping in the specific store 300 after the donor 30 assigns the donee 40 and completes donation data and procedure followed by an examination evaluation executed by the charity 200, and then the specific store 300 would send back shopping content and a account to the secure donation system 1, so as to enable transparent overall donation and usage process.

The database 10 is used to store at least donation intention data of the donor 30, requirement data of the donee 40, and merchandise and/or service transaction data of the specific store 300. That is, the donor 30, the donee 40, and the specific store 300 must provide these previously described donation and shopping data to the secure donation system 1, wherein the specific store 300 cooperates with the secure donation system 1, so as to provide merchandise information and shopping behavior data, wherein the donee 40 provides basic data and the requirement data. Additionally, the database 10 records data including bank account and/or automatic transfer of the donor 30, so as to enable the bank to get the donation from the donor 30 after paying a shopping bill of the donee 40 in the specific store 300.

The resource allocation module 11 is used to analyze and compare the donation intention data with the requirement data, so as to generate donee data meeting the donation intention data. The requirement data is a reference data with respect to demand of the donee 40 previously mentioned by the donee 40 and performed with multi-evaluation. The donor 30 may provide the donation intention data of himself, for instance, the donee 40 who has urgent requirement or has assigned a merchandise, etc. after login the secure donation system 1. At last, the resource allocation module 11 generates a donee list meeting the requirement for the donor 30 to select by analyzing and matching the requirement data and the donation intention data.

Specifically, the requirement data of the donee 40 comprises evaluation data of the donor 30, evaluation data of the charity 200, record data of shopping habit of the donee 40, and/or data that how much amount of donation has the donee 40 received. In other words, generation of the requirement data is constructed by multiple evaluation which comprises previously evaluating requirement content of the donee 40 by the charity 200, for instance, urgency level, amount of requirement, belonging to luxury or not, etc., requirement evaluation of the donor 30 with respect to the donee 40, and judging if it is closing to the donation intention of the donor 30 by previously shopping habit of the donee 40, etc. Moreover, judgment of donee requirement would be affected under consideration of demand of other donees if the donee 40 has received times or amount of donation reaching certain quantity. Further illustratively, the requirement data described previously may having different evaluation data or content of evaluating weight in different embodiment.

The donation module 12 is used to be provided for the donor 30 to choose the donee 40 based on a donee data meeting the donation intention data generated by the resource allocation module 11, and to generate a donation usage certificate after verifying the donation data including the donation intention data and the donee data. The donation module 12 is used to provide for the donor 30 to choose a donated object, and used to get donation data generated from reference data related to the donor 30 and the donee 40 after verifying the donation, so as to generate the donation usage certificate used as donation usage certification.

The authorization module 13 is used to transmit the donation usage certificate to an electronic device 41 of the chosen donee 41, so as to permit the donee 40 to perform verification and shopping in the specific store 300 via the electronic device 41. The authorization module 13 transmits the donation usage certificate to the electronic device 41 held by the donee 40, and then the donee 40 may execute verification and shopping in the specific store 300 according to the donation usage certificate, wherein the specific store 300 is a shopping permitted store that previously made contract. The donee 40 performs data transmission with the secure donation system 1 via its surrounding information processing devices. The electronic device 41 is used to receive the donation usage certificate, so as to permit the donee 40 who holds the electronic device 41 to perform verification or shopping in the specific store 300, wherein the electronic device 41 which may be a general mobile phone or a smart mobile phone, etc. and its verification and shopping procedure with respect to the specific store 300 will be elaborated later.

Particularly, the donation usage certificate comprises a public key exclusively belonging to the donee 40 and the donor 30, donation data, and expiratory date. Since the donation usage certificate comprises the public key exclusively belonging to the donee 40 and the donor 30, the donation would be used only through verification of a private key of the donee 40. Additionally, the donation usage certificate further comprises random number data for avoiding reply attack, etc. That is, since the donation usage certificate considers the private key of the donee 40 to be a signature, relevant people is only permitted to open it. Furthermore, anyone may perform true and false examination of donation content via the public key, hence not only contributing to transparent donation but also achieving destination of non-repudiation donation.

In conclusion, a mechanism of matching the requirement data with the donation intention data provided in the secure donation system of the present invention does not merely enable the donor to assign a donated object in order to trace usage of donation. Tracing usage of donation is not achieved by prior donation or prior electronic donation which performs concentration donation with single account. Besides, since donation does not go through many people, donation procedure disaster or possibility of improper use of donation are reduced while avoiding disadvantages of that donation must be delivered to the charity first then transferred to the donee such that the donor is unable to trace usage of donation.

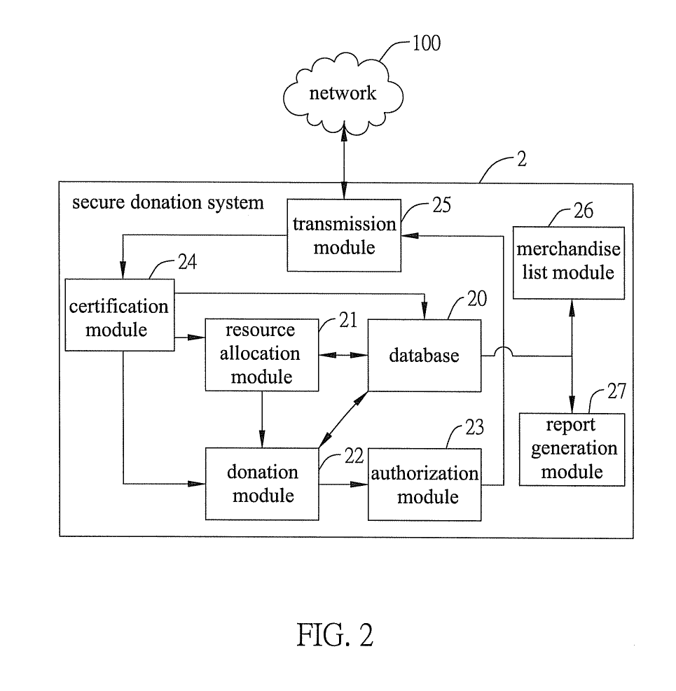

Please refer to FIG. 2 showing a system architecture diagram of the secure donation system in accordance with a particular embodiment of the present invention. As illustrated in FIG. 2, the secure donation system 2, similar to content described in previous FIG. 1, similarly comprises the database 20 for storing related data, the resource allocation module 21 for comparing the donation intention data of the donor with the requirement data of the donee, the donation module 22 for generating the donation usage certificate, and the authorization module 23 for transmitting the donation usage certificate. Properly, in the embodiment, the secure donation system 2 further comprises a certification module 24, a transmission module 25, a merchandise list module 26, and a report generation 27. In the embodiment, the secure donation system 2 transmits data to the information processing devices of the donor, the donee, the specific store, and the charity similarly via the network 100.

The certification module 24 is used to be provided for the donor, the donee, and the specific store to login and verify. A user of the secure donation system 2 has to execute identity verification first and login via the certification module 24 of the secure donation system 2 each time, then operate related functions of donation. Data verified by the certification module 24 is stored in the database 20, probability transmitted to the resource allocation module 21 for requirement match, or transmitted to the donation module 22 for procedures of donation confirmation, etc. Hence, the certification module 24 ensures legal behavior of the user.

The transmission module 25 is used for the donor, the donee, and the specific store to transmit data via the network. The transmission module 25 communicates with every external information processing device via the network. For example, the authorization module 23 transmitting the donation usage certificate to the donee is executed also via the transmission module 25.

The merchandise list module 26 is used to generate a merchandise list according to barcode, price, and name of the merchandise transmitted from the specific store, so as to be provided for the donor and the donee to inquiry. Specifically, the database 20 of the secure donation system 2 stores merchandise data including barcode, price, and name, etc. provided by the specific store, so as to be provided for the donor or the donee to inquiry. It may be considered as a reference while the donee requests requirement, or be used while the donor chooses the donee who requires certain merchandises as a donated object.

The report generation module 27 is used to generate a financial statement including donation data and shopping account data stored in the database 20 for a user to inquiry. The financial statement records all data processed by the secure donation system 2, so as for not only specific people to check but also others to inquire usage of donation. Besides, each shopping account of the financial statement corresponds to a user signature, hence random generation or private change is infeasible for the system.

Illustration herein, the financial statement is completed by an asymmetric encryption and decryption method. Since a public key is only a pseudo random number, a user name substituted by the public key has anonymous effect. Moreover, the shopping account data of the specific store would be uploaded to the financial statement and be encrypted via the public key of the donor, hence bill content is viewed only by the donor. Additionally, since the shopping account comprises this shopping amount, signatures of the donee and the specific store, the secure donation system 2 would renew a corresponding signature if the financial statement is revised.

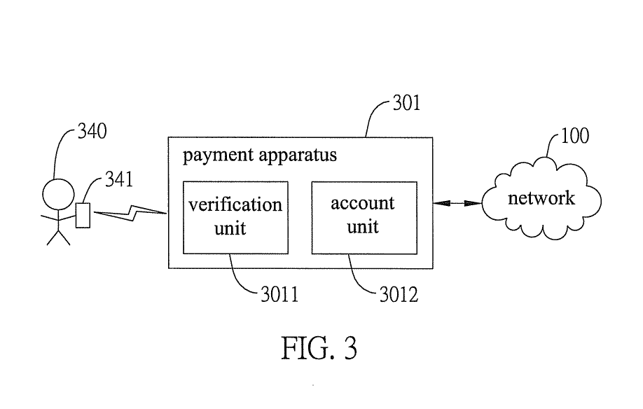

Please refer to FIG. 3 showing a system architecture diagram of a payment apparatus of the specific store in accordance with the present invention. As illustrated in FIG. 3, the specific store has a payment apparatus 301 for verifying shopping with respect to an electronic device 341 of a donee 340. The payment apparatus 301 comprises a verification unit 3011 and an account unit 3012. In the embodiment, the payment apparatus 301 transmits data to the secure donation system similarly via the network 100. Illustration herein, the specific store described previously transmits data to the secure donation system via an information processing device. Hence, the information processing device of the specific store may be the payment apparatus 301, or two separated devices respectively having connection function and data transmission function.

The verification unit 3011 is used for the specific store to verify the donation usage certificate of the electronic device 341 via the payment apparatus 301. In other words, the verification unit 3011 of the payment apparatus 301 is used to verify the electronic device 341, so as to confirm that the donation usage certificate is stored in the electronic device 341 and correspond to the right donation data, besides, further to check if there is enough balance for shopping.

Particularly, the electronic device 341 executes verification with respect to the payment apparatus 301 in Bluetooth Wireless Transmission Mode and/or Voice Channel Mode. Simply, identity verification during shopping process is executed via short distance transmission technology. Identity verification may be executed via choosing Bluetooth Wireless Transmission Mode if the donee holds a mobile phone having Bluetooth device.

Furthermore, under consideration of no Bluetooth device in the mobile phone of the donee while installation of any software is impossible, identity verification may be executed in Voice Channel Mode, that is, the donee calls a server of the secure donation system and keys in his own code and password through an automatic answering mechanism of the server, then the secure donation system feedbacks a sound similar to fax, at this time, identity verification may be executed in Voice Channel Mode via putting the mobile phone beside the payment apparatus by the donee.

The account unit 3012 is used for the specific store to generate the shopping account data with respect to shopping of the user via the payment apparatus 301. The shopping account data is generated according to shopping content of the donee 340 and transmitted to the database of the secure donation system for storing, wherein the specific store asks the bank for payment on the basis of the shopping account data. As previously described, since the shopping account data is encrypted through the public key of the donor, an inquire is supplied for the donor only.

In conclusion, the secure donation system of the present invention not only enhances data security but also achieves anonymous donor and donee, and non-repudiation of donation behavior or shopping behavior. Moreover, the donor may clearly trace each use of donation, and hence doubt of that worthy donation is unknown after donating the charity is reduced, and passing through many people is unnecessary via a postpaid mechanism, so as to avoid mistrust of donation treat.

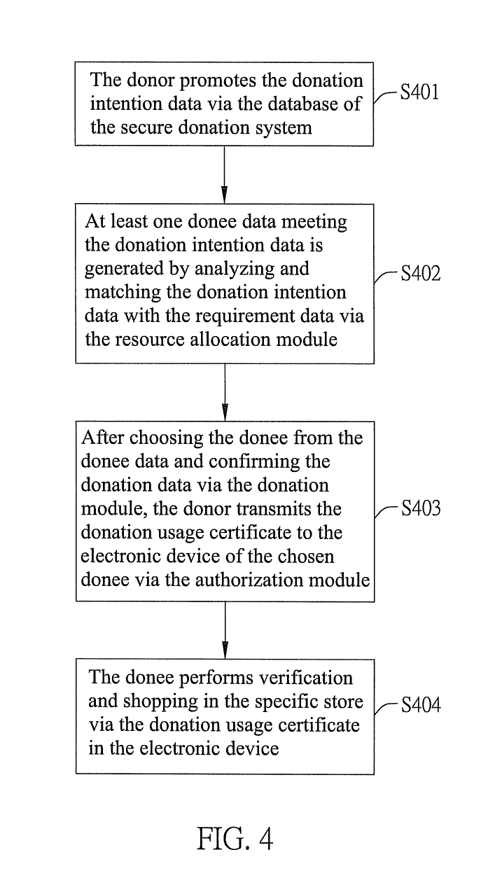

Please refer to FIG. 4 showing a flow chart of steps of a secure donation method in accordance with the present invention. As illustrated in FIG. 4, the secure donation method of the present invention is executed via the secure donation system described previously. The donor chooses the donee meeting requirement provided by the charity, so as to permit the donee performs shopping in the specific store via the donation usage certificate. In a step S401, the donor promotes the donation intention data via the database of the secure donation system. The donor generates the donation intention data according to his expect use of donation after entering the secure donation system, so as to find data of eligible donee, wherein the donation intention data is stored in the secure donation system. Next, a step S402 is executed.

In step S402, at least one donee data meeting the donation intention data is generated by analyzing and matching the donation intention data with the requirement data via the resource allocation module. In step S402, the donation intention data of the donor and the requirement data of the donee stored in the database are analyzed and match with each other, thereby finding the donee data meeting the donation intention data of the donor. Next, a step S403 is executed.

In step S403, the donor transmits the donation usage certificate to the electronic device of the chosen donee via the authorization module after choosing the donee from the donee data and confirming the donation data via the donation module. Specifically, the donation usage certificate which is provided for the donee as a basis of shopping verification is generated by the secure donation system and transmitted to the electronic device of the donee after the donor chooses the donated object meeting the donation intention. Particularly, the electronic device may a portable digital device. Next, a step S404 is executed.

In step S404, the donee performs verification and shopping in the specific store via the donation usage certificate in the electronic device. Particularly, the donee goes shopping after performing verification with the payment apparatus of the specific store via the donation usage certificate while enough donation is confirmed. Hence, besides donation delivered by the donor is not handled by the donee, the shopping content is checked if it meets the requirement or not.

In an embodiment of the present invention, before step S401, a step of generating the requirement data of the donee by the secure donation system for the donor in previous step S403 to choose the donee via the donation module is further comprised in the method. That is, the requirement data of the donee is generated in advance through multi-evaluation comprising conducting evaluation by the charity according to application content, regulating via data of previous shopping habit of the donee and/or donation amount received by the donee, etc., thereby assisting the donor to find the donee who is close to the intention and has high urgency.

Additionally, in the previous step S404, the electronic device performs verification with the payment apparatus of the specific store in Bluetooth Wireless Transmission Mode and/or Voice Channel Mode. As mentioned previously, data verification may be executed in Bluetooth Wireless Transmission Mode if the mobile phone of the donee is the smart mobile phone, and in Voice Channel Mode if it is the general one, thereby the specific store may verify if the donee has the right to use the donation or not.

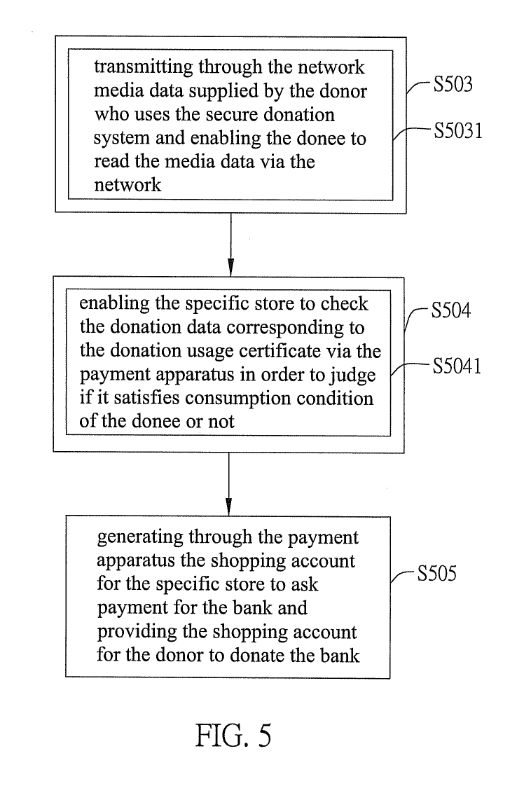

Please refer to FIG. 5 showing a flow chart of steps of the secure donation method in accordance with a particular embodiment of the present invention. As illustrated in FIG. 5, steps S503 and S504 are similar to steps S403 and S404 in FIG. 4. The difference between FIG. 5 and FIG. 4 is that steps S503 and S504 further comprise steps S5031 and S5041, respectively, and a step S505 for generating the shopping account is further comprised following step S504.

In a particular embodiment of the present invention, step S503 further comprises step S5031 of transmitting through the network media data supplied by the donor who uses the secure donation system and enabling the donee to read the media data via the network. In step S5031, the donor may through the secure donation provide multimedia data for the donee to watch it online or may transmit it to the donor via the network, thereby encouraging the donor and increasing interaction of both sides, wherein the donor may generate the media data by peripheral information processing device and transmit it to the secure donation system later. Since the donee could not be known and concern message could not be transmitted via the traditional donation method, multimedia concern herein could not be achieved by the traditional donation method.

In another embodiment of the present invention, step S504 further comprises step S5041 of enabling the specific store to check the donation data corresponding to the donation usage certificate via the payment apparatus in order to judge if it satisfies consumption condition of the donee or not. As described previously, the payment apparatus not only verifies the right of the donee to use the donation but also checks that if balance of the donation is enough for the payment of the shopping content. The shopping behavior is completed if there is no problem. The donee may go shopping next time in the same method if there is balance after usage.

In another particular embodiment of the present invention, the method further comprises step S505, following step S504, of through the payment apparatus generating the shopping account for the specific store to ask payment for the bank and providing the shopping account for the donor to donate the bank. The payment apparatus generates the shopping account of the consumption after shopping process is completed. Except transmitting the shopping account to the database of the secure donation system for storing, the specific store asks the payment for the bank according to the shopping account, wherein at last the donor pays the payment for the bank.

Additionally, steps S401 to S404 of FIG. 4 and S505 of FIG. 5 described previously further comprise a step of storing the donation data and the shopping account data in the database, so as for the user to inquire via the secure donation system. That is, the whole donation process, the shopping process, and the account store in the secure donation system, so as for all users to inquire according to different identity. Transparent donation usage record may be provided by recording the whole donation and shopping process, thereby reducing doubt of worthy donation.

Furthermore, shopping payment behavior of the present invention is similar to shopping mode of credit card, that is, the specific store asks payment for the bank after the donee goes shopping, and then the bank asks it for the donor. The method may enable the donation not to pass through the charity or the donee, so as to enable the donor not to worry worthy donation.

In conclusion, the secure donation system of the present invention constructs the requirement in advance according to demand condition of the donee, so as to enable the donor to choose the donee meeting the donation intention. The donee may go shopping in the specific store according to the donation usage certificate after receiving the donation usage certificate, and then the specific store asks the payment for the bank according to the shopping record. Hence, the donor may clearly trace the donation and may enhance his donation willing. Furthermore, the donation and shopping mode described previously without passing through the charity or the donee may reduce possible mistrust. Moreover, the donation data achieves anonymous effect via asymmetric encryption and decryption method. The financial statement provides for anyone to inquire according to each identity, thereby providing safe and relieved donation system and method.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A secure donation system connectible to information processing devices of a donor, a donee, and a specific store via a network, comprising:
a database for storing donation intention data of the donor, requirement data of the donee, and merchandise and/or service transaction data of the specific store;
a resource allocation module for generating donee data meeting the donation intention data by analyzing and matching the donation intention data with the requirement data;
a donation module for the donor to choose the donee from the donee data meeting the donation intention data generated by the resource allocation module and for generating a donation usage certificate after confirming donation data including the donation intention data and the donee data; and
an authorization module for transmitting the donation usage certificate to an electronic device of the chosen donee, so as for the donee to perform verification and shopping in the specific store via the electronic device.

2. The secure donation system of claim 1, further comprising:
a certification module for the donor, the donee, and the specific store to login and perform verification; and
a transmission module for the donor, the donee, and the specific store to transmit data via the network.

3. The secure donation system of claim 1, wherein the donation usage data comprises a public key, the donation data, and expiratory data belonging exclusively to the donee and the donor.

4. The secure donation system of claim 3, wherein the donation usage certificate performs verification via private key of the donee.

5. The secure donation system of claim 1, wherein the requirement data of the donee comprises evaluation data of the donor, evaluation data of charity, and record data of shopping habit of the donee, and/or data of donation received by the donee.

6. The secure donation system of claim 1, wherein the specific store has a payment apparatus for verifying shopping with the electronic device, the payment apparatus comprising:
a verification unit for the specific store to perform verification with the donation usage certificate in the electronic device via the payment apparatus; and
an account unit for the specific store to generate shopping account data of shopping of the donee via the payment apparatus.

7. The secure donation system of claim 6, wherein the electronic device performs verification with the verification unit in Bluetooth Wireless Transmission Mode and/or Voice Channel Mode.

8. The secure donation system of claim 6, wherein the shopping account data is used as a basis that the specific store asks payment for a bank and is encrypted via a public key of the donor for the donor to inquiry.

9. The secure donation system of claim 1, further comprising a merchandise list module for displaying merchandises, wherein the merchandise list module is used to generate a merchandise list based on barcode, price, and name of the merchandises transmitted by the specific store, so as for the donor and the donee to inquiry.

10. The secure donation system of claim 1, further comprising a report generation module for generating a financial statement including the donation data and shopping account data, wherein the financial statement is stored in the database, so as for a user to inquiry.

11. A secure donation method executed by the secure donation systems of claim 1, comprising the steps of:
(a) enabling the donor to submit the donation intention data via the database of the secure donation system;
(b) analyzing and matching the donation intention data with the requirement data via the resource allocation module, so as to generate at least one donee data meeting the donation intention data;
(c) after the donor chooses the donee from the donee data via the donation module and confirms the donation data, transmitting the donation usage certificate to the electronic device of the chosen donee via the authorization; and
(d) enabling the donee to perform verification and shopping in the specific store via the donation usage certificate in the electronic device.

12. The secure donation method of claim 11, before step (a), further comprising a step of generating the requirement data of the donee by the secure donation system, so as for the donor in step (c) to choose the donee via the donation module.

13. The secure donation method of claim 11, wherein step (c) further comprises a step of via the network transmitting media data provided by the donor through the secure donation system and enabling the donee to receive the media data.

14. The secure donation method of claim 11, wherein step (d) further comprises a step of enabling the specific store to check the donation data corresponding to the donation usage certificate via the payment apparatus, so as to judge if shopping condition of the donee is satisfied or not.

15. The secure donation method of claim 11, further comprising step (e) of generating shopping account via the payment apparatus, so as for the specific store to ask payment for the bank, and for the donor to pay for the bank according to the shopping account.

16. The secure donation method of claim 15, wherein steps (a) to (e) further comprise a step of storing the donation data and the shopping account data in the database, so as for the user to inquire via the secure donation system.
